(19) United States
(12) Patent Application Publication
(10) Pub. No.: US 2016/0139785 A1
(43) Pub. Date: May 19, 2016

(54) MULTI-MODAL COMMUNICATIONS

(71) Applicant: Cisco Technology, Inc., San Jose, CA (US)

(72) Inventors: Keith GRIFFIN, Oranmore (IE); Jonathan ROSENBERG, Freehold, NJ (US)

(21) Appl. No.: 14/542,607

(22) Filed: Nov. 16, 2014

(51) Int. Cl. G06F 3/0484

(52) U.S. Cl. CPC G06F 3/04847; G06F 3/04842

(57) ABSTRACT

In one embodiment, a method includes presenting a first mode of communication on a screen display of a mobile communication device, receiving a request to present a second mode of communication on the mobile communication device, determining relative priority for the first and second modes of communication, based on said relative priority, formatting a presentation including at least representations of both the first and second modes of communication, and presenting the formatted presentation on the screen display on the mobile communication device.

### FIELD OF THE INVENTION

The present invention generally relates to the sharing of a display screen between multiple modes of communication.

### BACKGROUND OF THE INVENTION

Mobile communication devices such as, for example, smartphones and computer tablets, are typically configurable to provide a variety of modes of communication, including, for example: voice, voice over IP (VOIP), instant messaging (IM), email, SMS text messages, online video conference sessions, social media, screen sharing, etc.

U.S. patent application Ser. No. 13/803,079 (hereinafter “the '079 patent application”) by Stephen Quatrano, entitled “COLLABORATIVE GROUP AND CONTENT MANAGEMENT UTILIZING USER ACTIVATED COLLABORATION THREADS”, filed Mar. 14, 2013, assigned to the common assignees of the present application discloses a system that facilitates the implementation of collaboration threads for access to content associated with such various modes of communication for collaborative groups of participants at client devices.

### BRIEF DESCRIPTION OF THE DRAWINGS

The present invention will be understood and appreciated more fully from the following detailed description, taken in conjunction with the drawings in which:

FIG. 1 is a simplified pictorial illustration of an exemplary mobile communication device, constructed and operative in accordance with embodiments of the present invention;

FIG. 2 is a schematic illustration of the exemplary mobile communication device of FIG. 1;

FIG. 3 is a block diagram of a process to performed by the exemplary mobile communication device of FIG. 1; and

FIGS. 4 and 5 are simplified pictorial illustrations of the exemplary mobile communication device of FIG. 1.

### DESCRIPTION OF EXAMPLE EMBODIMENTS

### Overview

A method includes presenting a first mode of communication on a screen display of a mobile communication device, receiving a request to present a second mode of communication on the mobile communication device, determining relative priority for the first and second modes of communication, based on said relative priority, formatting a presentation including at least representations of both the first and second modes of communication, and presenting the formatted presentation on the screen display on the mobile communication device.

A UI method includes presenting a shared presentation on a touchscreen, where the shared presentation includes an original foreground presentation and an original background presentation, detecting a twisting motion between two objects moving in contact with the touchscreen, where the two objects are detected switching between the original foreground presentation and the original background presentation, and reformatting the shared presentation by defining the original foreground presentation as a new background presentation, and defining the original background presentation as a new foreground presentation, and presenting the reformatted shared presentation on the touchscreen.

### DESCRIPTION

It will be appreciated that mobile communication devices typically comprise integrated display screens which tend to be significantly smaller than non-integrated display screens which are used typically in conjunction with desktop personal computers. For example, current smartphone display screen sizes may typically range from four to six inches, and personal tablet screen sizes may typically range from seven to ten inches. In comparison, non-integrated display screens are typically at least twenty inches or more.

It will also be appreciated that mobile communication devices may also be computing devices capable of running a variety of non-communication applications. However, mobile communication devices may typically be configured to prioritize communication applications vis-à-vis other types of applications. Specifically, mobile communication devices operating systems tend to prioritize voice and video applications. Such prioritization may typically be expressed in terms of control of the display screen. For example, if a non-prioritized application is running on a mobile communication device, an incoming voice call may typically be displayed on the display screen (i.e. in the foreground), whereas the operating system may move the non-prioritized application to the background. Mobile communication devices may similarly prioritize video conference sessions.

The inventors of the present invention have realized that such prioritization may not always be convenient for the user. For example, a user may be participating in an IM chat at the time that a video conference session begins. The user may wish to wrap up the IM chat with one last post before fully engaging in the video conference. In some cases, the user may even wish to continue with the IM chat while simultaneously monitoring the video conference.

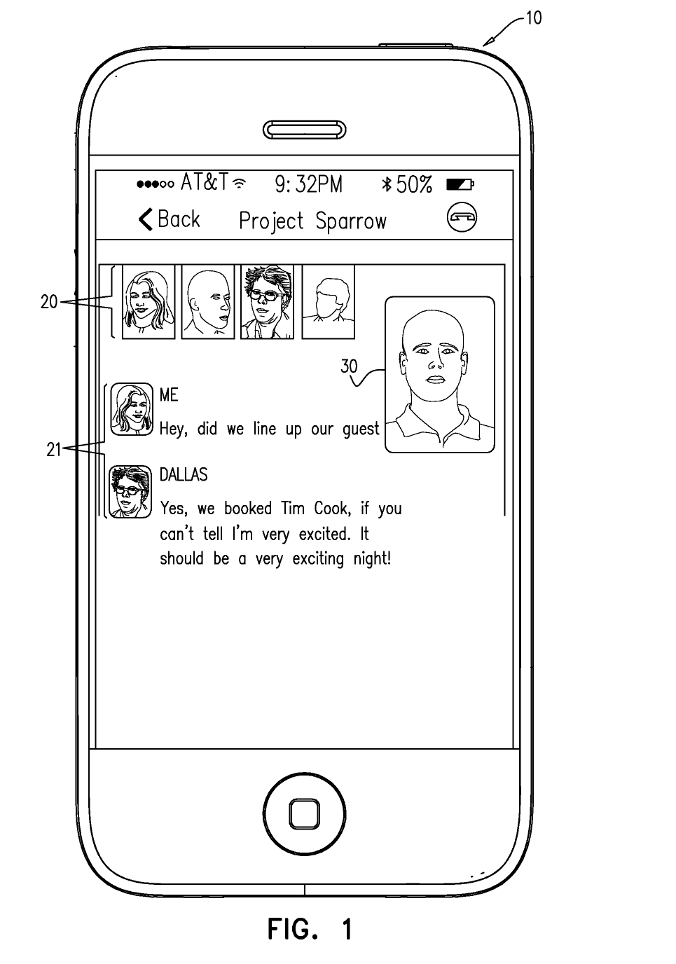

Reference is now made to FIG. 1 which illustrates an exemplary mobile communication device 100, constructed and operative in accordance with embodiments of the present invention. In accordance with an exemplary embodiment, mobile communication device 100 may support a shared presentation of two different modes of communication. Participant avatars 20 and IM posts 21 may represent an ongoing IM chat. Video feed 30 may represent an ongoing live feed from a video conference session. It will be appreciated that the user of device 100 may continue to participate in the IM chat while also viewing the video conference session.

It will also be appreciated that the positioning and size of video feed 30 vis-à-vis avatars 20 and posts 21 may be configurable. While the exemplary illustration of FIG. 1 depicts video feed 30 as a thumbnail sized window “floating” or superimposed on an IM chat screen, other configurations may be possible. For example, video feed 30 may alternatively be allocated the top or bottom half of the display screen. Alternatively, video feed 30 may also be allocated the majority of the display screen. In such a case, the IM chat may be reduced to the bottom of the display screen with only the last IM post 21 visible.

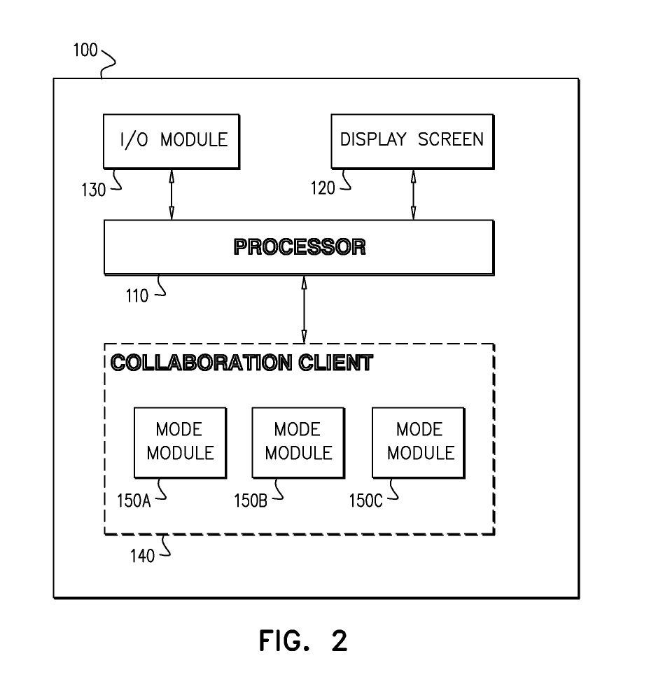

Reference is now made to FIG. 2 which illustrates an exemplary mobile communication device 100, constructed and operative in accordance with embodiments of the present invention. It will be appreciated that mobile communication device 100 may be implemented using any suitable mobile communication device, such as, for example, a smartphone or computer tablet. Device 100 comprises processor 110, display screen 120, I/O module 130 and collaboration client 140.

Mobile communication device 100 comprises hardware and software components, such as are well-known in the art. Processor 110 may be operative to execute instructions stored in a memory (not shown). It will be appreciated that mobile communication device 100 may comprise more than one processor 110. For example, one such processor 110 may be a special purpose processor operative to at least execute collaboration client 140 according to a method described herein. In some of the embodiments described hereinbelow, display screen 120 may be a touchscreen operative to detect user interface (UI) gestures input as commands to an operating system and/or application running on device 100. Such UI gestures are typically entered by one or more of the user's fingers or suitable implement such as a pen or stylus coming in contact or at least close proximity with display screen. I/O module 130 may be any suitable hardware and/or software component operative to use protocols such as are known in the art to receive and send various modes of communication such as, for example, the modes of communication supported by the system of the '079 patent.

Collaboration client 140 may be a software or hardware component that may be executed by processor 110 to facilitate multiple modes of communication on device 100 such as, for example, the modes of communication supported by the system of the '079 patent. In accordance with an exemplary embodiment of the present invention, collaboration client 140 may comprise a multiplicity of mode modules 150, each of which may be configured to provide one or more different modes of communication. For example, mode module 150A may provide IM communication; mode module 150B may provide voice communication; and mode module 150C may provide video conference communication.

Alternatively or in addition, the functionalities of some or all of mode modules 150 may be provided via plugins to non-component communication clients. For example, the functionality of mode module 150A may be provided via a plugin to an IM chat client such as, for example, Cisco Jabber or Microsoft Lync; the functionality of mode module 150B may be provided via a plugin to a native phone application or Skype; the functionality of mode module 150C may be provided via a plugin to Cisco WebEx or GoToMeeting from Citrix Systems, Inc.

It will be appreciated that the configuration of collaboration client 140 may be at least in in part a function of the operating system in use on device 100. For example, devices 100 using an iOS operating system may not provide full support for multitasking applications. Accordingly, to provide the presentation of the embodiment of FIG. 1 for a device 100 using iOS, collaboration client 140 may be implemented as a single application with integrated components. However, an Android operating system may support multitasking applications. Accordingly, if device 100 uses Android, collaboration client 140 may also be implemented as a framework application using plugins to communicate with non-integrated components to provide various modes of communication.

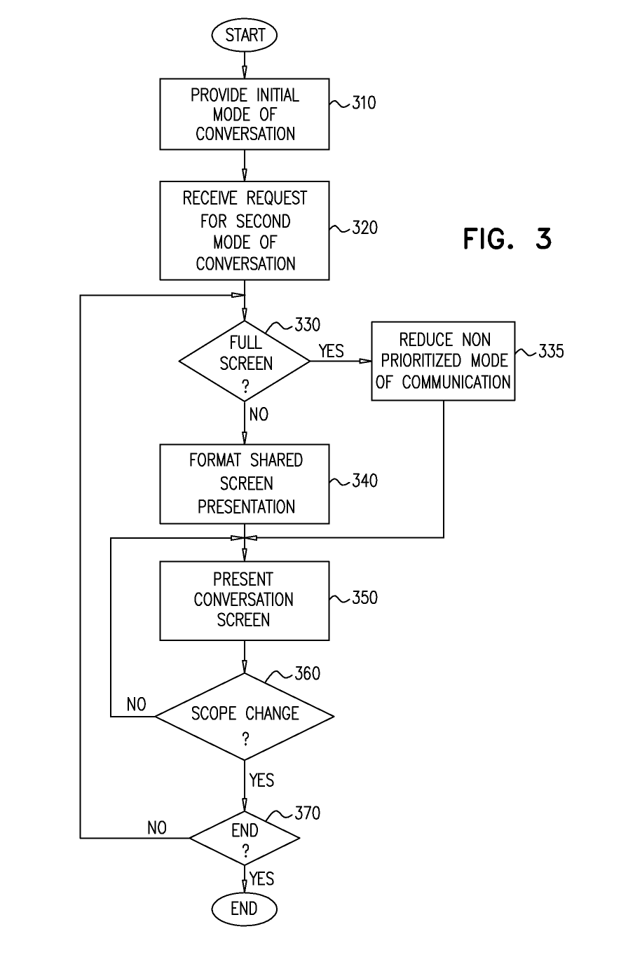

Reference is now made to FIG. 3 which illustrates a communication mode management process 300 to be performed by collaboration client 140 on device 100. Collaboration client 140 may provide (step 310) an initial mode of communication. For example, collaboration client may provide access to an IM chat such as presented in FIG. 1. It will be appreciated that the manner in which step 310 may be performed may be a function of the manner in which collaboration client 150 may be implemented. For example, if, as per the exemplary embodiment of FIG. 2, collaboration client 140 may comprise integrated mode modules 150, the relevant mode module 150 (mode module 150A as per the hereinabove example) may be executed to provide an IM chat. If collaboration client 140 does not comprise integrated mode modules 150, a non-integrated component (such as for example, Cisco Jabber) may be invoked to provide similar functionality.

Collaboration client 140 may receive (step 320) a request for a second mode of communication for device 100. The source of such a request may be, for example, an incoming voice call or video conference session. Alternatively, the request may be initiated from within the ongoing first mode of communication. For example, if the first mode of communication from step 310 is an IM chat, an IM post may comprise a link to a video conference session. Alternatively, or in addition, collaboration client 140 may be configured to enable one or more participants using a given mode of communication to initiate a second mode of communication for the participants. For example, using the exemplary embodiment of FIG. 2, mode module 150A may be configured with a feature to enable a participant of an IM chat to initiate a different mode of communication between the same participants, e.g. to start a video conference using mode module 150C.

Collaboration client 140 may determine whether either of the two modes of communication should be presented using a full screen, i.e. using all of the available display area on display screen 120 (step 330). It will be appreciated that collaboration client 140 may be configured to enable a user of device 100 to designate default conditions according to which a new communication mode may or may not be presented as a full screen application. For example, collaboration client 140 may be configured such that all new modes of communication (i.e. the second mode of communication requested in step 320) be opened at least initially as full screen applications. Alternatively, collaboration client 140 may be configured such that all new modes of communication may not be opened, at least initially, as full screen applications.

Alternatively, or in addition, different defaults may be assigned to different modes of communication. For example, phone calls or video conference sessions may by default be opened using the full screen, whereas IM chats and email clients may not default to using the full screen when opened as a second mode of communication. Alternatively, or in addition, different modes of communication may be prioritized vis-à-vis other modes of communication. For example, a phone call may default to a full screen unless the first mode of communication is a video conference session.

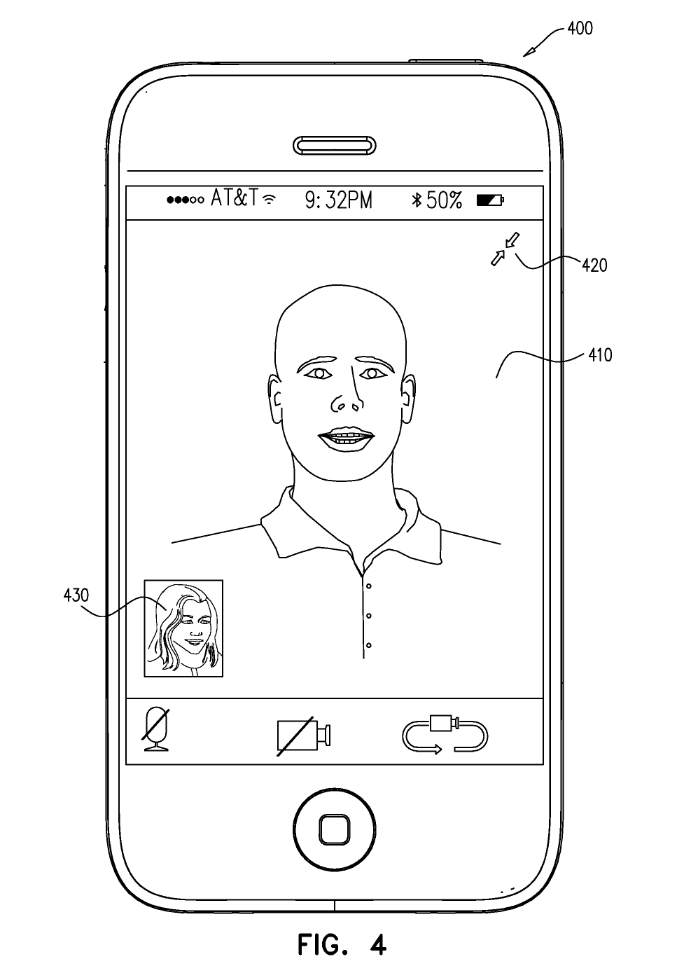

If either one of the modes of communication is designated for full screen presentation, collaboration client 140 may reduce (step 335) the other, non-prioritized mode of communication, e.g. to an icon or thumbnail. Collaboration client 140 may then present (step 350) the conversation screen, i.e. display screen 120 (FIG. 1) as formatted to represent multiple modes of communication. Reference is now made to FIG. 4 which illustrates a mobile communication device 400, constructed and operative in accordance with an exemplary embodiment of the present invention. Mobile communication device 400 may be generally similar to mobile communication device 100 as per the embodiment of FIG. 2. Full screen video 410 may be an exemplary representation of a prioritized mode of communication as determined in step 330, such as, for example, a video call or a video conference session. Accordingly, full screen video 410 may represent the incoming video of a video conference session.

Reduced mode icon 430 may represent the non-prioritized mode of communication, for example, the IM chat of the embodiment of FIG. 1. It will be appreciated that the representation of reduced mode icon 430 in the form of a user's avatar 30 (FIG. 1) may be exemplary; other representations, iconic or otherwise, may also be supported by process 300. For example, in the context of an exemplary IM chat, the most recent post may be displayed instead of an iconic representation.

It will be appreciated by one of skill in the art that the prioritized mode of communication, i.e. as per the example hereinabove the video call or video conference session presented as full screen video 410, may be presented in the foreground of mobile communication device 400. Accordingly, actions or commands input by the user may by default be associated with the prioritized mode of communication. Similarly, the non-prioritized mode of communication may be presented in the background. Actions or commands input by the user may by default not be associated with the non-prioritized mode of communication.

It will however be appreciated that collaboration client 140 may be configured to allow some or all of the “reduced”, i.e. non-prioritized, presentation's functionality to be available. For example, collaboration client 140 may be configurable to enable components such as audio receivers/speakers and/or cameras to be active for a video conference session even while it may nominally be presented in the background.

It will be appreciated that a user may wish to change the relative prioritization of the modes of communication. Sizing button 420 may be configured to facilitate a user interface (UI) gesture to resize full screen video 410. For example, the user may touch and drag sizing button horizontally, vertically or diagonally to resize full screen video 410, thereby effectively opening a window to present at least a representation of the other, non-prioritized, mode of communication. Alternatively, or in addition, the user may resize full screen video 410 may using a pinch-like UI gesture. Alternatively, or in addition, collaboration client 140 may support the use of a popup menu option using methods known to those of skill in the art to request to resize full screen video 410. In any case, the screen “real estate” made available by the resizing action may be used to present a fuller representation of the second, non-prioritized mode of communication.

It will be appreciated that as per the exemplary embodiment of FIG. 1, collaboration client 140 (FIG. 2) may be configured such that the first mode of communication, i.e. an IM chat, may be prioritized higher than the second mode of communication, i.e. an incoming video conference. In such a case, the exemplary embodiment of FIG. 1 may represent the result of step 350, where IM avatars 20 and posts 21 may represent the prioritized mode of communication, and video feed 30 may represent the reduced, non-prioritized mode of communication.

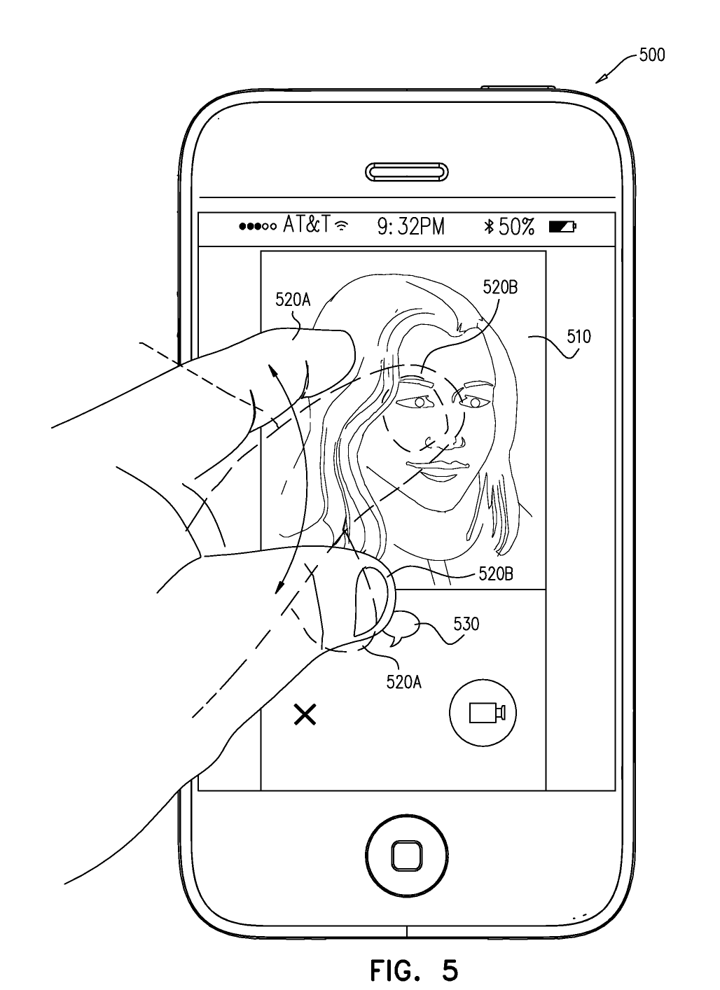

Reference is now made to FIG. 5 which illustrates exemplary mobile communication device 500, constructed and operative in accordance with an exemplary embodiment of the present invention. Priority screen video 510 may represent the prioritized mode of communication, e.g. a video conference session as per the previous exemplary embodiments, and reduced mode icon 530 may represent the non-prioritized mode of communication, e.g. an IM chat as per the previous exemplary embodiments.

It will be appreciated that as discussed hereinabove mobile communication devices 100, 400 and 500 may be configured with a touchscreen such as display screen 120. Collaboration client 140 may be configured to enable a user to switch priorities between the two associated modes of communication via a “twist and switch” UI gesture. A twist and switch UI gesture may comprise placing fingers 520A and 520B on priority screen video 510 and reduced mode icon 530, and “twisting” them such that finger 520A moves to reduced mode icon 530 and finger 520B moves to priority screen video 510. In such a case, collaboration client 140 may switch the priority and associated formatting between the modes of communication referenced by priority screen video 510 and reduced mode icon 530. It will be appreciated by one of skill in the art that the depiction of fingers 520 may be exemplary; a twist and switch UI gesture may be input using any suitable object(s) generally in contact or at least close proximity to display screen 120. For example, a stylus, pen, pencil, etc. may be substituted for one or more of fingers 520.

It will also be appreciated that the priority for the non-prioritized mode of communication may be changed via a UI gesture or menu option. For example, if reduced mode icon 530 is double tapped, collaboration client 140 may determine that that the associated mode of communication is to be prioritized and displayed using a full screen representation.

It will further be appreciated that the location of the elements associated with the modes of communication may be moved by the user. For example, video feed 30 (FIG. 1) may be dragged using known methods to a different location superimposed on top of avatars 20 and/or posts 21.

Returning to FIG. 3, collaboration client may determine whether or not there has been a request to change the scope (step 360) of the respective representations of the modes of communication. For example, if, as described hereinabove, the priority mode of communication was resized or switched using sizing button 420, a UI gesture, or a menu option. If no change has been requested, process 300 may loop to step 350 and continue to present the modes of communication as previously formatted.

If there has been a request to change the scope (step 360), collaboration client 140 may check whether or not one or both of the modes of communication has ended (step 370), i.e. the communication(s) terminated in accordance with methods known in the art. For example, the user may have exited from one of the modes of communication, or the mode of communication was ended by external parties, e.g. a phone call or video conference session was terminated by a second participant. If so, the remaining mode of communication (if there is one) may default to a full screen representation and process 300 may end. If neither mode of communication has ended (step 370), control may return to step 330 and processing may proceed as before per whatever changes were detected in step 360.

It will be appreciated by those of skill in the art that the order of the steps of process 300 may be exemplary; other processing flows providing generally the same functionality may also be supported by the present invention.

It will also be appreciated that as discussed hereinabove, the operating system of mobile communication devices 100, 400 and 50 may impact on the configuration of collaboration client 140 and/or mode modules 150. If the operating system does not support multitasking applications, mode modules 150 may be integrated within the framework of a single application such as collaboration client 140 in order to facilitate representation of multiple modes of communication as part of the same presentation. However, if multitasking applications is supported, mode modules 150 may also be implemented as independent applications using plug-ins to communicate with collaboration client 140. Similarly, some or all of the functionality of collaboration client 140 may be provided by native operating system functionality.

It will further be appreciated that if multitasking applications is supported, collaboration client 140 may be configured to interact with other applications via the operating systems without the use of plug-ins. For example, process 300 may be implemented to provide reduced or prioritized presentations of modes of communication vis-a-via applications that are not associated with modes of communication per se. For example, an incoming video conference session may be presented as video feed 30 over the presentation of a document reader application or a game being played by a participant in the video conference session.

It will be appreciated that if multitasking applications is supported, the twist and switch UI gesture described hereinabove may also be used to switch relative priorities between an ongoing mode of communication and an application that is not associated with modes of communication. It will similarly be appreciated that in such an environment where multitasking applications is supported, the twist and switch UI gesture as described hereinabove may also be implemented to switch relative priorities between two applications that are not associated with modes of communication.

It will also be appreciated that the first and second modes of communication may actually be the same mode of communication. For example, they may both represent video conference session. Depending on the configuration of process 300 and/or subsequent user input, the two video conferences may be presented in a variety of presentations. For example, if they are assigned equal priority, they may be presented sharing display screen 120 in a generally equal manner. Alternatively or in addition, by default greater priority may be assigned to either the first or second instance of a given mode of communication.

It will also be appreciated that the relative prioritization of the first and second mode of communication may be at least in part a function of whether or not they are associated with the same “conversation” as defined by association with the same collaboration thread as per the '079 patent application. For example, a second mode of communication may be prioritized either higher or lower depending on whether or not it is part of the same conversation as the first mode of communication. For example, if the first mode of communication is an IM chat, collaboration client 140 may be configured to assign a higher priority to an incoming video conference session that is associated with the same conversation, whereas a video conference session from a different conversation may be assigned a lower priority. Alternatively, depending on the configuration of collaboration client 140, higher priority may be assigned to a second mode of communication that is not associated with the same conversation as the first mode of communication. Alternatively or in addition, the relative prioritization may be at least a function of the specific mode used for the first and/or second mode of communication.

It will also be appreciated that process 300 may effectively circumvent an operating system's default prioritization of voice and/or other applications at the expense of a mode of communication currently in use. It will also be appreciated that process 300 may improve the efficiency of mobile communication devices 100, 400 and 500 by facilitating generally simultaneous participation in multiple modes of communication in an easy-to-use and streamlined manner.

It will also be appreciated that process 300 may also be implemented for non-mobile communication devices. For example, process 300 may be implemented generally as described hereinabove for systems using projected UI on a pane of glass. It will similarly be appreciated that process 300 is not limited to implementation on currently sized mobile communication devices. Process 300 may be implemented on any suitable mobile and/or non-mobile communication device that supports the concurrent execution of multiple instances of communication, without regard to the specific size of the device's associated display area.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method comprising:
presenting a first mode of communication on a screen display of a mobile communication device;
receiving a request to present a second mode of communication on said mobile communication device;
determining relative priority for said first and second modes of communication;
based on said relative priority, formatting a presentation comprising at least representations of both said first and second modes of communication; and
presenting said formatted presentation on said screen display on said mobile communication device.

2. The method according to claim 1 and wherein said first and second modes are from among: instant messaging (IM), video conferencing, voice, voice over IP (VOIP), email, SMS text messages, screen sharing and social media.

3. The method according to claim 1 and wherein said first and second modes of communication are integrated in a single application.

4. The method according to claim 1 and wherein said first and second modes of communication are provided by separate applications.

5. The method according to claim 1 and also comprising:
receiving a request to change said relative priority;
reformatting said presentation based on said request to change; and
presenting said reformatted presentation on said screen display on said mobile communication device.

6. The method according to claim 5 and wherein:
said display screen is a touchscreen; and
said receiving comprises detecting a user interface (UI) gesture.

7. The method according to claim 6 and wherein said detecting comprises:
detecting a twisting motion between two objects moving in contact with said touchscreen, wherein said two objects are detected switching between said representations of both said first and second modes of communication; and
switching said relative priority between said first and second modes of communication.

8. The method according to claim 6 and wherein said detecting comprises:
detecting a double tap on one of said representations of both said first and second modes of communication; and
increasing said relative priority for either said first or second mode of communication in accordance with a location for said detected double tap.

9. The method according to claim 1 and wherein said first and second modes of communication are two instances of a same mode of communication.

10. The method according to claim 1 and wherein said determining is based on default conditions according to which said modes of communication are presented on said touchscreen.

11. The method according to claim 10 wherein said default conditions are user configurable.

12. The method according to claim 10 and wherein said default conditions are a function of at least an order in which said first and second modes of communication are initiated on said mobile communication device.

13. The method according to claim 10 and wherein said default conditions are a function of at least a type of communication used for said first and second modes of communication.

14. The method according to claim 10 and wherein said default conditions are a function of at least a relationship between said first and second modes of communication, wherein said relationship is defined according to participation in a collaboration thread.

15. The method according to claim 1 and wherein:
said determining comprises:
determining which of said said first and second modes of communication is a non-prioritized mode of communication, and
determining which of said first and second modes of communication is a prioritized mode of communication; and
said presenting said formatted presentation comprises:
presenting said prioritized mode of communication as a foreground presentation, and
presenting said non-prioritized mode of communication as a background presentation.

16. The method according to claim 15 and wherein presenting said non-prioritized mode of communication comprises presenting video.

17. The method according to claim 1 and also comprising improving the efficiency of said mobile communication device by facilitating simultaneous participation in multiple said modes of communication.

18. A UI method comprising:
presenting a shared presentation on a touchscreen, wherein said shared presentation comprises an original foreground presentation and an original background presentation;
detecting a twisting motion between two objects moving in contact with said touchscreen, wherein said two objects are detected switching between said original foreground presentation and said original background presentation; and
reformatting said shared presentation by defining said original foreground presentation as a new background presentation, and defining said original background presentation as a new foreground presentation; and
presenting said reformatted shared presentation on said touchscreen.

19. The method according to claim 18 and wherein:
said touchscreen is implemented in a mobile communication device; and
said original foreground and background presentations are associated with modes of communication.

20. A mobile communication device comprising:
a screen display configured to at least present a first mode of communication;
an I/O module configured to at least receive a request to present a second mode of communication on said mobile communication device;
a processor; and
a collaboration client to be executed by said processor, wherein said collaboration client is configured:
to determine relative priority for said first and second modes of communication;
based on said relative priority, format a presentation comprising at least representations of both said first and second modes of communication, and
to instruct said screen display to present said formatted presentation.
